(19) United States
(12) Patent Application Publication
(10) Pub. No.: US 2009/0238622 A1
(43) Pub. Date: Sep. 24, 2009

(54) IMAGE FORMING APPARATUS, CONTROL METHOD AND CONTROL PROGRAM THEREOF

(75) Inventor: Keishi Inaba, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/403,858

(22) Filed: Mar. 13, 2009

(30) Foreign Application Priority Data
Mar. 19, 2008 (JP) 2008-072221

(51) Int. Cl. G03G 15/00

(52) U.S. Cl. 399/393

(57) ABSTRACT

The present invention improves print performance in image forming apparatuses capable of roller feeding and air feeding. To accomplish this, an image forming apparatus having an air feeding unit that carries out air feeding and a roller feeding unit that carries out roller feeding is provided with a determination unit configured to determine according to an attribute of a print job whether to carry out air feeding or whether to carry out roller feeding, and a control unit configured to control the image forming apparatus according to a result of the determination of the determination unit.

### BACKGROUND OF THE INVENTION

1. Field of the Invention

The present invention relates to an image forming apparatus, a control method for controlling the image forming apparatus, and a program for controlling the image forming apparatus.

2. Description of the Related Art

Image forming apparatuses such as copiers, printers, and facsimile machines have sheet storage units (sheet feeding trays) that store recording papers (recording sheets), and the recording papers are transported from the sheet storage units to an image forming unit by a sheet feeding unit. The image forming unit forms an image on the recording paper that has been transported in this manner, then the recording paper on which the image has been formed is discharged outside the apparatus. Ordinarily, a roller feeding device that transports sheets to a downstream side using rotation of feeding rollers is used as the sheet feeding unit of an image forming apparatus such as this. In the roller feeding device, the surface of the rollers is constituted by an elastic material such as rubber, and the feeding performance thereof is greatly dependent on a coefficient of friction of the roller surfaces. Accordingly, there is a problem in that the feeding performance is not stable due to such factors as change in the outer shape of the rollers due to wear, change in the quality of the material of the rollers over time, and change in the coefficient of friction of the roller surfaces due to adherence of paper dust and the like. There are also problems in that the roller feeding device cannot support high speed feeding and is unable to support recording papers of varying types of surface conditions.

In order to address these problems, Japanese Patent Laid-Open No. 06-199437 proposes an air feeding device that employs an air separation method. This air feeding device is provided with a sheet sorting unit that sorts upper portion sheets by blowing air onto an edge portion of sheets stacked in a sheet stacking portion, and an adhesive transport unit that causes an uppermost sheet to adhere to a transport belt for transport.

Furthermore, there are conventional image forming apparatuses that can store recording papers of various sizes in different sheet storage units by providing multiple sheet storage units for performing image formation on various papers. And image forming apparatuses are also common that can store a large volume of recording papers inside the apparatus and carry out a large volume of image forming by storing same-size recording papers in a plurality of sheet feeding trays.

Problems such as the following are present in image forming apparatuses having multiple sheet feeding trays when air feeding devices are used.

The air feeding device provided in each of the sheet feeding trays is provided with a unit that sorts the upper portion sheets by blowing air onto an edge portion of the sheets and a unit that causes the uppermost sheet to adhere to the transport belt, and air pressure is used in these units. When using air pressure, a time delay is produced until the air pressure acts on the sheet in the sheet feeding tray after air extraction/intake has been carried out for the feeding operation. Conceivable causes of this include the length of the ducting, the time for switching on/off valves inside the ducting for switching the air for each sheet feeding tray, and a delay in the sorting time due to the weight of the sheets. In this manner, air feeding devices have a problem in that a delay is produced in the feeding operations since a time delay is produced until the air pressure acts on the sheets when commencement of feeding operations is instructed, and job throughput is reduced.

Furthermore, Japanese Patent Laid-Open No. 2002-040881 describes examining whether or not same size papers are present in a sheet storage unit other than a sheet storage unit that has run out of paper, and when there are same size papers in another sheet storage unit, papers are continued to be fed from that sheet storage unit without stopping feeding operations. This function reduces operation stoppage times caused by running out of papers and increases the efficiency for print jobs.

Furthermore, Japanese Patent Laid-Open No. 05-286590 proposes an air feeding device in which the delay in switching between sheet feeding trays is eliminated by constantly applying air to two sheet feeding units. Here, the extraction and supply of air to multiple copy trays is distributed using a single air extraction device and air supply device. Then the pressure is set so as to enable paper feeding when the on/off valves of two trays are open, and valve control is carried out by an on/off control unit so that two on/off valves are constantly open. With this control, two on/off valves are constantly open, and therefore there is no air pressure fluctuation (or if there is, it is extremely slight) even when paper feeding is carried out with two trays simultaneously. In this way, when switching sheet feeding trays, the air pressure at the tray side can be swiftly changed to a value necessary for operation. In this way, it is proposed to prevent reductions in print job throughput by eliminating loss in the switching of sheet feeding trays.

Compared to roller feeding, air feeding in the aforementioned manner is capable of supporting very high speed image forming apparatuses. However, since it takes time to enable air feeding, air feeding has a problem in that its first print is slow (the time from when the image forming apparatus receives an instruction to execute a job until the first printed output is obtained).

As described above, conventionally, delays in switching between sheet feeding trays have been eliminated by applying air to multiple sheet feeding units. However, causing multiple sheet feeding units to operate necessitates a constant application of air, which increases the scale of the air application devices and increases the power consumption of the image forming apparatus.

### SUMMARY OF THE INVENTION

It is desirable to eliminate the above-mentioned conventional problems. One embodiment of the present invention improves print performance in image forming apparatuses capable of roller feeding and air feeding.

One aspect of the present invention provides an image forming apparatus, comprising an air feeding unit configured to carry out feeding using air, a roller feeding unit configured to carry out feeding without using air, a determination unit configured to determine according to a number of sheets to be printed by executing a print job whether to execute the print job by carrying out the air feeding or whether to execute the print job by carrying out the roller feeding, and a control unit configured to perform control based on a result of a determination by the determination unit so that the air feeding unit or the roller feeding unit is selected to execute the print job.

Another aspect of the present invention provides a control method for an image forming apparatus, the image forming apparatus having an air feeding unit that carries out air feeding using air and a roller feeding unit that carries out roller feeding without using air, the control method comprises determining according to a number of sheets to be printed by executing a print job whether to execute the print job by carrying out the air feeding or whether to execute the print job by carrying out the roller feeding, and performing control based on a result of a determination by the determination unit so that the air feeding unit or the roller feeding unit is selected to execute the print job.

Further features of the present invention will be apparent from the following description of exemplary embodiments with reference to the attached drawings.

### BRIEF DESCRIPTION OF THE DRAWINGS

FIG. 1 is a configuration diagram of digital multifunctional peripheral according to an embodiment of the present invention.

FIG. 2 is an outline cross-sectional view for describing a structure of the digital multifunctional peripheral according to the present embodiment.

FIG. 3 is an external perspective view of an operation unit of the digital multifunctional peripheral according to the present embodiment.

FIG. 4 is a cross-sectional view for describing a sheet adhesive transport unit that is provided at a right cassette deck according to the present embodiment.

FIG. 5 is a diagram for describing a drive unit of the sheet adhesive transport unit according to the present embodiment and is a bottom view as viewed from the recording sheet side.

FIG. 6 is a lateral view as viewed from the left side of FIG. 5 of the sheet adhesive transport unit according to the present embodiment.

FIG. 7 is a flowchart for describing a process of switching between roller feeding and air feeding in the digital multifunctional peripheral according to the first embodiment.

FIGS. 8A to 8C are flowcharts for describing processing of switching between roller feeding and air feeding in a digital multifunctional peripheral according to a second embodiment.

FIG. 9 is a diagram showing one example of jobs to be executed continuously in the digital multifunctional peripheral according to the second embodiment.

### DESCRIPTION OF THE EMBODIMENTS

Preferred embodiments of the present invention will now be described in detail with reference to the drawings. It should be noted that the relative arrangement of the components, the numerical expressions, and numerical values set forth in these embodiments do not limit the scope of the present invention unless it is specifically stated otherwise.

### First Embodiment

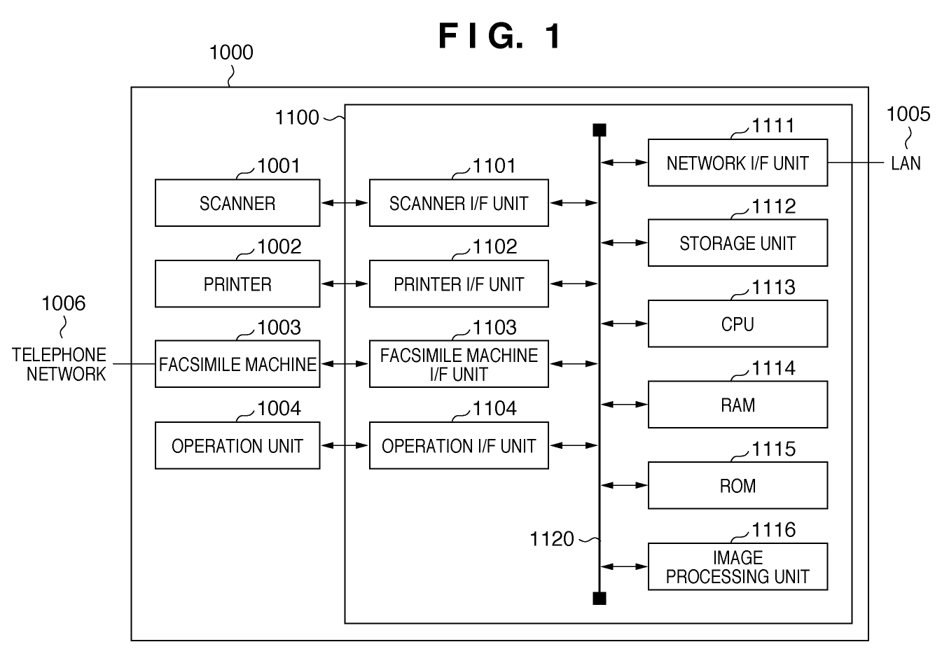

FIG. 1 is a configuration diagram of a digital multifunctional peripheral 1000 as one example of an image forming apparatus according to a first embodiment of the present invention.

In the digital multifunctional peripheral 1000, a scanner 1001, a printer 1002, a facsimile machine 1003, and an operation unit 1004 are connected to a controller 1100. The operation unit 1004 has a display unit that displays warnings and messages to a user, and various keys and switches or the like operated by the user. There is also a connection to a LAN 1005 via a network interface (I/F) unit 1111, and a telephone network 1006 is connected to the facsimile machine 1003.

Next, description is given of a configuration of the controller 1100. A CPU 1113 is connected to a system bus 1120. Via this system bus 1120, the CPU 1113 is connected to a scanner I/F unit 1101, a printer I/F unit 1102, a facsimile machine I/F unit 1103, an operation I/F unit 1104, and the network I/F unit 1111. Further still, the CPU 1113 is connected to a storage unit 1112, a RAM 1114, a ROM 1115, and an image processing unit 1116. Description is given of operation of these units according to a flow of signals between the units.

Image data that is supplied by the scanner 1001 undergoes image processing by the image processing unit 1116 via the scanner I/F unit 1101, after which it is stored in the RAM 1114. Furthermore, control commands issued from the scanner 1001 are transferred to the CPU 1113. Print data received through the LAN 1005 is rasterized (rendered) by the image processing unit 1116 via the network I/F unit 1111, after which it is transferred and stored in the RAM 1114. Furthermore, control commands received at the network I/F unit 1111 are transferred to the CPU 1113. Facsimile data received through the telephone network 1006 is transferred and stored in the RAM 1114 via the facsimile machine 1003. Furthermore, control commands supplied from the facsimile machine 1003 are transferred to the CPU 1113.

Under the control of the CPU 1113, image processing such as image rotation and scaling is applied by the image processing unit 1116 to these sets of image data that have been stored in the RAM 1114. After this, the data is sent to printer 1002 via the printer I/F unit 1102 or transmitted to the telephone network 1006 via the facsimile machine 1003.

Upon receiving a command requesting display to the operation unit 1004 from the scanner I/F unit 1101 or the facsimile machine 1003, the CPU 1113 displays the specified display content on the display unit of the operation unit 1004. Further still, when key operation is performed by the user at the operation unit 1004, the operation information thereof is supplied to the CPU 1113 via the operation I/F unit 1104. According to the operation content, the CPU 1113 determines whether or not to transfer the operation information received through the operation I/F unit 1104 to the scanner I/F unit 1101 or the facsimile machine 1003. Furthermore, the CPU 1113 performs input/output control of the image data based on the operation information. The network I/F unit 1111 enables the sending and receiving of data in accordance with communications protocols.

A control program of the CPU 1113 for coordinating this control is stored in the ROM 1115, and the CPU 1113 acts in accordance with the control program stored in the ROM 1115. It should be noted that the RAM 1114 is used as a work area when the CPU 1113 executes these various control processes.

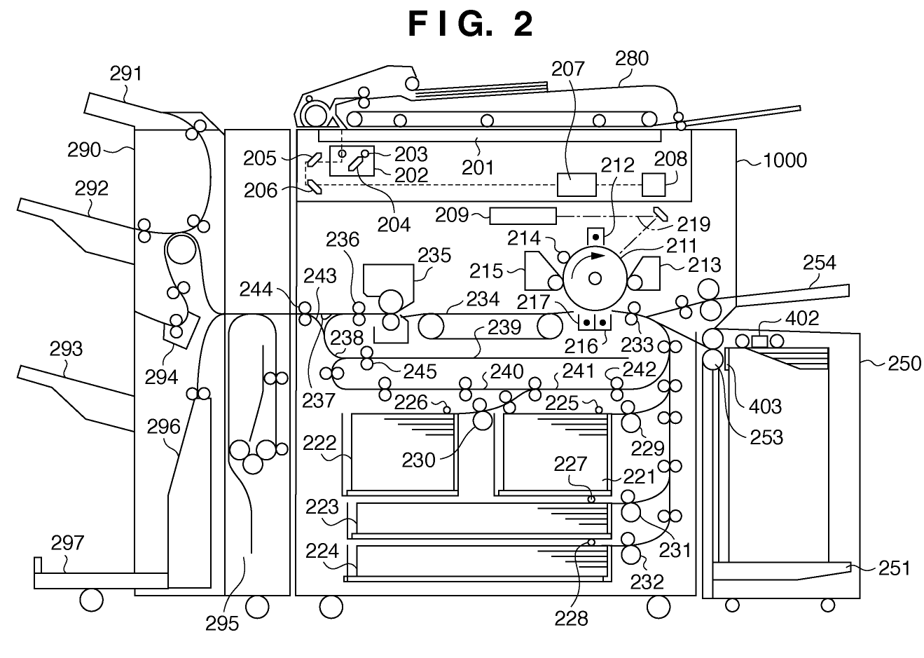

FIG. 2 is an outline cross-sectional view for describing a structure of the digital multifunctional peripheral 1000 according to the present embodiment.

An automatic document feeder (ADF) 280 is provided at an upper portion of the digital multifunctional peripheral 1000. A platen glass 201 is a platform onto which originals to be read are loaded. A scanner unit 202 has components such as a lamp 203 for lighting and a mirror 204, and the scanner unit 202 scans back and forth in a predetermined direction due to the rotation of a motor (unshown). Reflected light from the original, which is irradiated by light of the scanner unit 202, penetrates a lens 207 via the mirrors 204 to 206 and forms an image on an image sensor 208 (CCD sensor).

An exposure control unit 209 has components such as a laser and a polygonal scanner, and irradiates a laser light 219, which is modulated in accordance with image signals, which are electrical signals supplied from the image sensor 208 that have undergone image processing by the image processing unit 1116, onto a photosensitive drum 211. A primary charger 212, a developer 213, a transfer charger 216, a pre-exposure lamp 214, and a cleaning apparatus 215 are provided around the photosensitive drum 211.

The photosensitive drum 211 rotates in a direction shown by an arrow in FIG. 2 due to the rotation of a motor (not shown in diagram), and after its surface is charged to a desired electric potential by the primary charger 212, an electrostatic latent image is formed by the laser light 219 being irradiated from the exposure control unit 209. The electrostatic latent image formed on the photosensitive drum 211 in this manner is developed by the developer 213 and becomes visible as a toner image.

On the other hand, transfer papers (also referred to as recording sheets or papers, and including sheets of materials other than paper such as OHP sheets) contained in a right cassette deck 221, a left cassette deck 222, an upper level cassette 223, and a lower level cassette 224 are picked up by the rotation of their respective pickup rollers 225, 226, 227, and 228. After this, the transfer papers are transported into the main unit due to the rotation of feeding rollers 229, 230, 231, and 232. The transfer papers transported into the main unit in this manner are fed to a transfer belt 234 by registration rollers 233. After this, the toner image that has been made visible on the photosensitive drum 211 is transferred to the transfer paper by the transfer charger 216. The surface of the photosensitive drum 211 is cleaned by the cleaning apparatus 215 after the toner image has been transferred and residual electric charge is eliminated by the pre-exposure lamp 214.

On the other hand, the transfer paper onto which the toner image has been transferred is separated from the photosensitive drum 211 by a separation charger 217 and sent to a fixing unit 235 by the transfer belt 234. The fixing unit 235 fixes the toner image onto the transfer paper using pressure and heat. The paper onto which the toner image has been fixed in this manner is discharged outside the main unit by the rotation of discharge rollers 236.

The multifunctional peripheral 1000 is provided with a deck 250 that can accommodate, for example, 4,000 sheets of transfer papers. The deck 250 employs a so-called air separation method and is a type that separates and feeds the papers in order from the uppermost transfer paper. A lifter 251 of the deck 250 rises according to the volume of the transfer papers. The transfer papers are sorted sheet by sheet by air ejected from an ejection duct 403. Then, the uppermost transfer paper is caused to adhere by a suction duct 402 and is sent into the main unit by the rotation of feeding rollers 253. Furthermore, a manual feeder 254 is provided that is capable of accommodating 100 sheets of transfer papers.

Further still, a discharge flapper 237 switches the route to a transport path 238 side or a discharge path 243 side. A lower transport path 240 turns over the transfer papers that have been fed out from the discharge rollers 236 via an inversion path 239, then guides the transfer papers into a re-feeding path 241. The transfer papers that have been fed by the feeding rollers 230 from the left cassette deck 222 are also guided to the re-feeding path 241. Re-feeding rollers 242 re-feed the transfer papers to the transfer unit provided with the aforementioned transfer charger 216 and the like.

Discharge rollers 244 are arranged near the discharge flapper 237, and transfer papers that have been switched to the discharge path 243 side by the discharge flapper 237 are discharged outside the machine.

When carrying out double sided recording (double sided copying), the discharge flapper 237 is raised upward and the transfer papers on which copying has been carried out are guided to the re-feeding path 241 via the transport path 238, the inversion path 239, and the lower transport path 240. At this time, the trailing edge of the transfer paper is completely withdrawn from the transport path 238 by reversing rollers 245 and is pulled into the inversion path 239 to a position where the transfer paper is sandwiched by the reversing rollers 245, then fed out to the lower transport path 240 by having the reversing rollers 245 caused to rotate in reverse. Then, when inverting and discharging the transfer paper from the main unit, the discharge flapper 237 is raised upward and the trailing edge of the transfer paper is pulled in by the reversing rollers 245 into the inversion path 239 until a position where the trailing edge remains on the transport path 238. After this, the transfer paper is turned over and fed out to the discharge rollers 244 side by reversing the rotation of the reversing rollers 245.

A discharge device 290 loads and aligns on a processing tray 294 the transfer papers that are discharged sheet by sheet from the digital multifunctional peripheral 1000. After one copy of image formation has been discharged, a bundle of recording papers is stapled and discharged to a discharge tray 292 or 293 as a bundle. The discharge tray 293 undergoes vertical movement control by a motor (not shown in diagram), and is moved so as to be in a position of a processing tray before commencement of image formation processing operations. Separator sheets to be inserted between the transfer papers that have been discharged are loaded on a paper tray 291. A z-folding machine 295 performs z-folding on the discharged transfer papers. Furthermore, a binding machine 296 carries out binding by collecting a copy of discharged transfer papers and performing center folding and stapling. A bundle of papers that has undergone binding in this manner is discharged to a discharge tray 297.

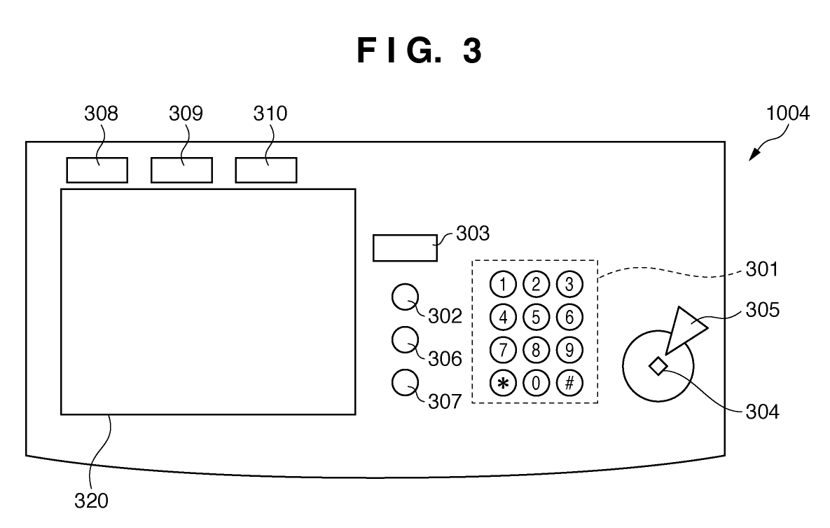

FIG. 3 is an external perspective view of the operation unit 1004 of the digital multifunctional peripheral according to the present embodiment.

A numeric keypad 301 is used for inputting numerical values such as settings for the number of image formation sheets and mode settings, and is also used for inputting telephone numbers or the like when performing facsimile machine settings. A clear key 302 is used when invalidating a setting that has been inputted by the numeric keypad 301. A reset key 303 is used when returning to predetermined values the values of the number of sheets for image formation, the operational mode, and the mode for the selected sheet feeding tray or the like that have been set. A start key 304 is a key that is pushed when commencing image formation operations. In the center of the start key 304 are a red and a green LED (not shown in diagram) that indicate whether or not image formation can be commenced, and in the case where image formation cannot commence, the red LED is lit, and in the case where image formation can commence, the green LED is lit. A stop key 305 is used when stopping a copy operation. A guide key 306 is a key that is pushed when unsure of the function of a certain key, and a description of the key whose function is not understood is displayed on a display unit 320. An interrupt key 307 is a key that is pushed when the user wishes to perform another task during image formation operations.

The display unit 320 is constituted by liquid crystals for example, and its displayed content changes according to a settings method so as to facilitate detailed method settings. Furthermore, a touch sensor is provided at a surface of the display unit 320, and a function is executed by touching with a finger or the like inside a frame of the function displayed on the display screen. A proof print function key, which is a key for executing a proof print, is also included therein. A copy function key 308, a fax function key 309, and a box function key 310 are keys that indicate copy, fax, and box functions. When any of these keys is pushed, the displayed content is switched in the display unit 320 of the operation unit 1004. When the copy function key 308 is pressed, various settings can be carried out relating to copying on a screen not shown in FIG. 3. Furthermore, when the fax function key 309 is pressed, various settings can be carried out relating to faxing on a screen not shown in FIG. 3. The box key 310 is a key that is pressed when storing image data to the storage unit 1112 or when printing out image data that is stored.

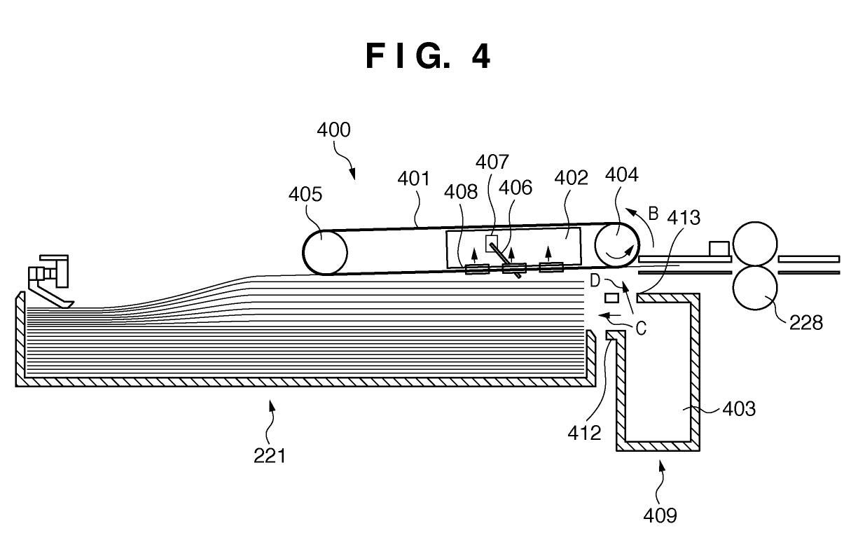

FIG. 4 is a cross-sectional view for describing a sheet adhesive transport unit 400 that is provided at the right cassette deck 221 according to the present embodiment. It should be noted that the sheet adhesive transport unit 400 may also be provided at the left cassette deck 222, the upper level cassette 223, the lower level cassette 224, and the deck 250 shown in FIG. 1. The digital multifunctional peripheral 1000 shown in FIG. 2 indicates an example in which the sheet adhesive transport unit shown in FIG. 4 is installed at the deck 250.

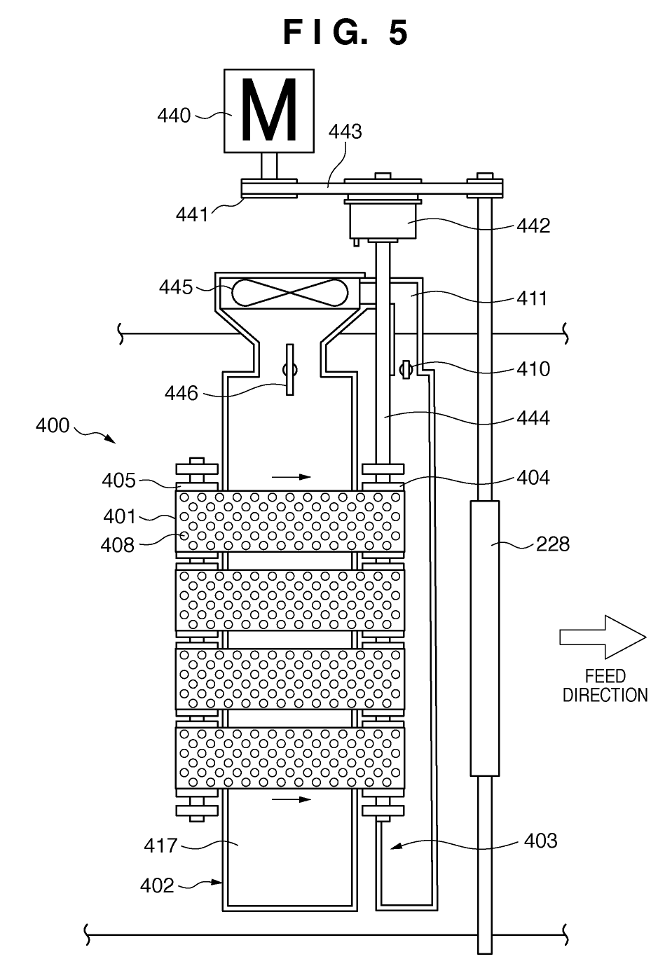

The sheet adhesive transport unit 400 is configured including components such as a transport belt 401, a drive unit shown in FIG. 5, the suction duct 402, and the ejection duct 403. The transport belt 401 is arranged with the feed direction side thereof set slightly upward above the cassette deck 221. The transport belt 401 is wound onto a drive roller 404 and an idler roller 405, and rotates in the arrow B direction accompanying rotation of the drive roller 404. Furthermore, suction holes 408 for suctioning and causing adherence of the transfer papers are formed on the surface of the transport belt 401. Furthermore, inside the suction duct 402 there is an adhesion sensor lever 406 that rotates upward when pressed by a recording sheet adhering to the transport belt 401. Further still, an adhesion sensor 407 is present that detects that the recording sheet has adhered to the transport belt 401 based on the upward rotation of the adhesion sensor lever 406 and outputs an adhesion signal. It should be noted that the mounting position of the sheet adhesive transport unit 400 varies for the cassette deck 221, 222, cassette 223, 224 and deck 250.

FIG. 5 is a diagram for describing the drive unit of the sheet adhesive transport unit according to the present embodiment and is a bottom view as viewed from the recording sheet side.

The drive unit causes the drive roller 404 to rotate, thereby causing the transport belt 401 to move in a direction shown by the arrows in the diagram. As shown in FIG. 5, the drive unit is configured provided with components such as a motor 440, a gear pulley 441, and a clutch 442. The driving force of the motor 440 is transmitted to an input shaft of the clutch 442 via the gear pulley 441 and a belt 443. An output shaft of the clutch 442 is connected to a drive shaft 444 of the drive roller 404. Accordingly, by using the CPU 1113 to cause the drive shaft 444 of the drive roller 404 to connect to the clutch 442, the driving force of the motor 440 is transmitted to the drive roller 404 via the drive shaft 444 and the transport belt 401 can be moved.

The suction duct 402 is a component for suctioning air through the suction holes 408 of the transport belt 401 and is arranged inside the track of the transport belt 401. By causing a fan 445 (FIG. 5) to operate and suctioning air through the suction duct 402, a negative pressure is produced near the suction holes 408. Furthermore, a suction valve 446 (FIG. 5) is arranged inside the suction duct 402 to adjust the suction amount of air. It should be noted that the air suctioned by the effect of the fan 445 flows to a separation portion 409 (FIG. 4) and is ejected.

The separation portion 409 assists the adhesive transport of the recording sheets by causing air to blow on the end portions of the recording sheets to lift and separate the recording sheets. The separation portion 409 is provided with components such as the ejection duct 403, a valve 410, a connecting duct 411, and the fan 445.

As shown in FIG. 4, the ejection duct 403 is arranged at the downstream side of the feed direction of the cassette deck 221 and below the drive roller 404. A sorting nozzle 412 that ejects air in the arrow C direction (horizontal direction) in FIG. 4 and a separation nozzle 413 that ejects air in the arrow D direction are formed in the ejection duct 403. The air ejected from the sorting nozzle 412 and the separation nozzle 413 is supplied from the fan 445 via the connecting duct 411. The valve 410 (FIG. 5) for adjusting the ejection amount of air is arranged at a connecting portion of the ejection duct 403 and the connecting duct 411. The degree of opening of the valve 410 is adjustable in accordance with instruction from the CPU 1113.

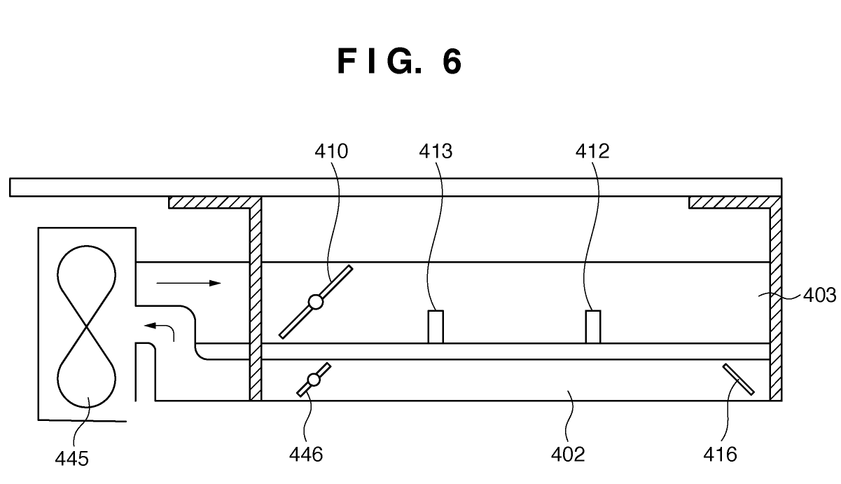

FIG. 6 is a lateral view as viewed from the left side of FIG. 5 of the sheet adhesive transport unit according to the present embodiment.

The fan 445 is driven by a motor (not shown in diagram) that rotates in accordance with instruction from the CPU 1113. As shown in FIG. 5, the fan 445 is also used in suctioning air from the aforementioned suction duct 402. That is, the fan 445 is jointly used for suctioning in the sheet adhesive transport unit 400 and for blowing air in the separation portion 409. FIG. 6 shows the air flows between the suction duct 402 and the ejection duct 403.

In the case where this configuration is employed, a case is conceivable, depending on the circumstances, that simply carrying out suctioning suitable for causing adhesion of the recording sheets will mean that the amount of air ejected from the ejection duct 403 is insufficient. Also, there may be cases where it is desired to eject air from the ejection duct 403 without carrying out suctioning in the suction duct 402. Thus, in the suction duct 402, the upstream side from an opening portion 417 is opened to be open to atmospheric air. A relief valve 416 is provided at the downstream side from the opening portion 417. Ordinarily, the relief valve 416 blocks the opening of the suction duct 402 due to its self-weight. However, when the negative pressure inside the suction duct 402 becomes a predetermined value or greater, it is pushed and opened by atmospheric pressure, and atmospheric air is introduced into the suction duct 402. That is, the relief valve 416 fulfils a role as a constant pressure valve. The feeding rollers 229 transport the recording sheets, which have been transported by the sheet adhesive transport unit 400, to the transfer unit, and are installed on the downstream side in the feed direction of the sheet adhesive transport unit 400.

Description is given regarding operation of air feeding by the deck 250, which is provided with the sheet adhesive transport unit 400 as shown in FIGS. 4 to 6.

First, the fan 445 and the motor 440 are caused to operate, the valve 410 opens, and air is supplied to the ejection duct 403. As a result, air is ejected in predetermined directions from the sorting nozzle 412 and the separation nozzle 413, thereby commencing the sorting process. At this time, the air ejected by the sorting nozzle 412 enters between the recording sheets, thereby sorting and lifting several sheets of the upper portion of the bundle of recording sheets. It should be noted that this sorting process is carried out continuously for a predetermined time necessary for the several sheets of the upper portion of the bundle of recording sheets that have been lifted to become stable.

After the above-described sorting process has been carried out for the predetermined time, the suction valve 446 is opened. When this happens, a negative pressure is produced inside the suction duct 402, and a recording sheet S of the uppermost surface of the recording sheets being lifted by the air from the sorting nozzle 412 adheres to the surface of the transport belt 401. The air ejected from the separation nozzle 413 at this time separates the recording sheet of the uppermost surface and the recording sheets other than that. In this way, none of the recording sheets other than the recording sheet of the uppermost surface is undesirably adhered together.

When the adhesion sensor 407 provided inside the suction duct 402 detects that the recording sheet has adhered to the surface of the transport belt 401, the clutch 442 engages and causes the transport belt 401 to rotate. As a result, the recording sheet adhered to the transport belt 401 is transported off in the feed direction. In this way, the recording sheets loaded in the deck 250 are fed sheet by sheet.

The above-described sorting process is one preparation process for carrying out air feeding from the cassette or deck that carries out air feeding (these are referred to collectively as air feeding units). When the preparation process such as this is completed, the air feeding unit is able to transition to a state capable of feeding, and feeding from the air feeding unit can commence.

Next, description is given regarding a process of switching between roller feeding and air feeding in the digital multifunctional peripheral according to the present embodiment.

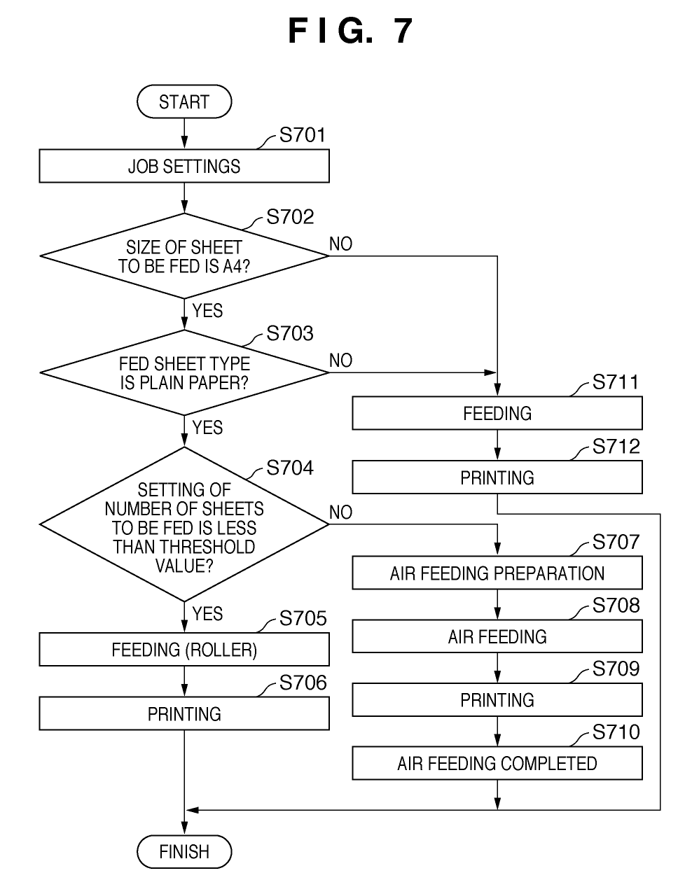

FIG. 7 is a flowchart for describing a process of switching between roller feeding and air feeding in the digital multifunctional peripheral according to the first embodiment. It should be noted that a program for executing this process is stored in the ROM 1115 and is executed under the control of the CPU 1113. It should be noted that the digital multifunctional peripheral in which control of switching air feeding is carried out according to the flowchart in the FIG. 7 is assumed to be loaded with A4 size plain papers in the deck 250, which is capable of air feeding. Furthermore, it is assumed that at least one of the right cassette deck 221, the left cassette deck 222, the upper level cassette 223, and the lower level cassette 224 (these use roller feeding) is loaded with A4 size plain papers. And cassettes other than the cassettes loaded with A4 size plain papers are loaded with papers of a size other than A4 or papers of a type other than plain paper.

This process commences by the digital multifunctional peripheral 1000 receiving a print job for air feeding. The digital multifunctional peripheral 1000 receives a print job for which feeding is possible from the deck 250 and any deck other than the deck 250, and the print job has job attributes such as the number of printing sheets, the printing sheet size, and the type of printing paper. For example, the number of print sheets indicates the number of print sheets such as 5, 10, 100, or the like. Furthermore, the printing sheet size indicates a printing sheet size such as A4, A3, or the like. Furthermore, the type of printing sheet indicates a type of printing sheet such as plain paper, OHP sheets, or the like. By setting the received job, in accordance with the job attributes, the number of printing sheets is set into the digital multifunctional peripheral 1000, feeding is carried out of papers equivalent to the number of printing sheets, and a deck is selected for executing printing from the printing sheet size and the type of printing sheet (S701).

Next, at step S702, a determination is carried out as to whether or not the size of the sheet to be fed is A4. The print job attributes of the received job are referenced and the procedure proceeds to step S703 when an A4 size is set.

At step S703, a determination is carried out as to whether or not the fed sheet type is plain paper. The printing sheet type attribute of the received job is referenced and the procedure proceeds to step S704 when plain paper is set.

At step S704, a determination is carried out as to whether or not the setting of the feeding number of sheets is less than a threshold value. The number of printing sheets attribute of the received job is referenced and the procedure proceeds to step S705 if this is the threshold value or less. For example, when the threshold value is 100, the procedure proceeds to step S705 if the setting of the number of printing sheets is 99 or less.

At step S705, feeding is executed from the roller feeding deck of A4 size plain papers, and at S706, print processing is executed and the processing of the print job is completed.

In the case where the setting for the number of printing sheets (number of output sheets) is 100 or greater at step S704, the procedure proceeds to S707. That is, in the case where the print job attributes of the received job indicate that the size of the sheet to be fed (output sheet size) is A4, the fed sheet type (output sheet type) is plain paper, and the setting for the number of sheets to be fed is the threshold value or greater, preparation for air feeding commences in steps S707 to S710. When preparation for printing with air feeding is completed at step S707, air feeding commences from the air feeding deck at step S708. Then, when printing processing is executed at step S709 and air feeding of the number of sheets set for the print job is completed, an air feeding completion process is carried out at step S710 and the processing of the print job is completed.

And in the case where the size of the sheet to be fed in the print job attributes of the received job is not A4 or in the case where the fed sheet type of the print job attributes is not plain paper, the procedure transitions from step S702 or S703 to step S711 and roller feeding is carried out from the feeding deck in accordance with the job attributes (S711). Following this, print processing (S712) is executed, and the processing of the print job is completed.

As described above, in the present embodiment, air feeding is carried out only in a case of a large volume print job of A4 plain paper, and in cases other than this, roller feeding is carried out. In this way, any effect of a delay accompanying execution of air feeding can be kept to a minimum. That is, in processing a small volume job, the job can be carried out swiftly by carrying out roller feeding, and in processing a large volume job, the effect of the delay in initializing air feeding becomes comparatively small per sheet. Thus, air feeding is carried out to reduce roller deterioration and to support high speed feeding.

It should be noted that in the flowchart of FIG. 7, it is assumed that A4 size plain paper is loaded in the deck 250, which is capable of air feeding, and one of the right cassette deck 221, the left cassette deck 222, the upper level cassette 223, or the lower level cassette 224, but it is also possible to assume that papers of other sizes or other types are loaded.

### Second Embodiment

Next, description is given regarding a second embodiment of the present invention. In the foregoing first embodiment, according to the attributes of each single job, air feeding was carried out when the number of sheets to be fed was the threshold value or greater and roller feeding was carried out when the number of sheets to be fed was less than the threshold value. However, in the second embodiment, the switching of air feeding and roller feeding is controlled by performing a determination for a plurality of jobs collectively. Other configurations and operations are equivalent to the first embodiment and therefore same symbols are assigned to same configurations and description thereof is omitted.

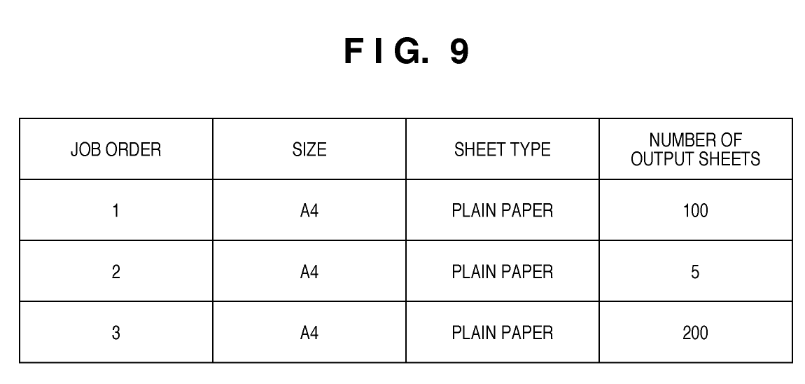

When the same processing as the first embodiment is carried out in a case of three continuous jobs as shown in FIG. 9, roller feeding is executed for only the second job, and air feeding is executed for the first and third jobs. However, this necessitates recommencing the processing for air feeding for the third job very soon after stopping air feeding when the first job is finished, which is inefficient. In other words, by performing control at the point in time when it becomes evident that air feeding has been determined for the first job and the third job so that air feeding operations of the first job are not stopped, it is possible to achieve further improvements in throughput.

The following three processes are conceivable as processes for this purpose.

1. Executing air feeding for the sandwiched roller feeding job.

2. Causing the air feeding mechanism to standby without stopping while executing the sandwiched roller feeding job.

3. Changing the order of the jobs to perform air feeding continuously.

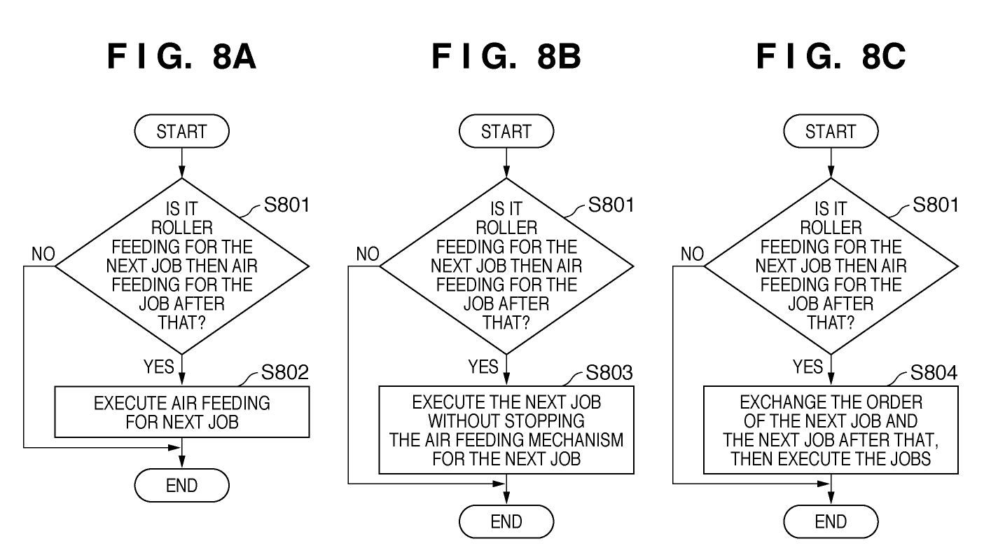

Description is given regarding these processes using the flowcharts in FIGS. 8A to 8C. First, the processes indicated in these flowcharts are carried out during job execution using air feeding.

First, at step S801, a determination is performed according to the method described in the first embodiment as to whether or not the next job to be executed after the air feeding job currently being executed is a roller feeding job and the next job after that is an air feeding job.

In FIG. 8A, when it is determined that the three jobs are in the order shown in FIG. 9, the procedure proceeds from step S801 to step S802, and control is performed such that the next job, namely the second job in FIG. 9, is executed using air feeding. For example, this control can be achieved by changing the sheet feeding trays set for the jobs.

Furthermore, in FIG. 8B, when it is determined that the three jobs are in the order shown in FIG. 9, the procedure proceeds from step S801 to step S803, and control is performed such that the air feeding mechanism is not stopped while the next job, namely the second job in FIG. 9, is being executed using roller feeding. This enables the preparation time to be reduced when performing air feeding for the third job.

Further still, in FIG. 8C, when it is determined that the three jobs are in the order shown in FIG. 9, the procedure proceeds from step S801 to step S804, and the second job and the third job shown in FIG. 9 are executed in a reversed order. In this way, jobs for which air feeding is to be carried out are executed continuously, which enables more efficient print processing to be carried out.

It should be noted that in the case where the second job is a roller feeding job and the time required for it is a predetermined value or greater, the air feeding mechanism may be stopped at the completion of the first job, then the preparation for air feeding may commence during the execution of the second job.

As described above, with the present embodiment, it is possible to efficiently switch between air feeding and roller feeding when processing a plurality of jobs.

### Other Embodiments

Detailed description has been given above concerning embodiments of the present invention, but the present invention may also be applied to a system constituted by a plurality of instruments, and may be applied to a device constituted by a single instrument.

It should be noted that the present invention may also be accomplished by supplying a software program that achieves the functionality of the foregoing embodiments directly or remotely to a system or a device, and having a computer of the system or device read out and execute the supplied program. In this case, there is no need for the embodiment to be in the form of a program as long as the functionality of a program is present.

Consequently, the actual program code to be installed on a computer to achieve the functional processing of the present invention on the computer may achieve the present invention. That is, the claims of the present invention also include an actual computer program for achieving the functional processing of the present invention. In this case the form of the program is of no concern and may be object code, a program to be executed by an interpreter, or script data supplied to an OS as long as the functionality of the program is present.

Various forms of recording media can be used for supplying the program. For example, this includes floppy (registered trademark) disks, hard disks, optical disks, magneto-optical disks, MO, CD-ROM, CR-R, CR-RW, magnetic tape, nonvolatile memory cards, ROM, DVD (DVD-ROM, DVD-R) and the like.

Additionally, as a technique for supplying the program, it is also possible to supply the program by using a browser of a client computer to connect to a website on the Internet and download the program from the website to a recording medium such as a hard disk. In this case, it may be the computer program of the present invention that is downloaded or it may be a compressed file having a self-installing function. Furthermore, it is also possible to achieve the present invention by having the program code that constitutes the program of the present invention divided into a plurality of files and downloading the respective files from different websites. That is, a WWW server that enables a plurality of users to download the program files for achieving the functional processing of the present invention on a computer is also included within the claims of the present invention.

Furthermore, the program of the present invention may also be in a form in which it is encrypted and stored on a storage medium such as a CD-ROM for distribution to users. In this case, a user who meets a predetermined condition may be allowed to download from a website via the Internet information of a key that unlocks the encryption and then put the encrypted program into an executable format by using the key information and installing the program on a computer.

Furthermore, the functionality of the foregoing embodiments, which is achieved by having a computer execute the program that has been read out, may additionally be achievable by other embodiments. For example, an OS or the like that runs on a computer may carry out a part or all of the actual processing according to instructions of the program such that the functionality of the above-described embodiments is achieved by the processing thereof.

Further still, the program that is read out from the recording medium may be written onto a memory provided in an extension board inserted into the computer or an extension unit connected to the computer. In this case, a CPU or the like provided in the extension board or extension unit may subsequently carry out a part or all of the actual processing according to instructions of the program such that the functionality of the foregoing embodiments is achieved by the processing thereof.

With the present invention, it is possible to improve print performance in image forming apparatuses capable of roller feeding and air feeding.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-072221 filed on Mar. 19, 2008, which is hereby incorporated by reference herein in its entirety.

What is claimed is:

1. An image forming apparatus, comprising:
an air feeding unit configured to carry out feeding using air,
a roller feeding unit configured to carry out feeding without using air,
a determination unit configured to determine according to a number of sheets to be printed by executing a print job whether to execute the print job by carrying out the air feeding or whether to execute the print job by carrying out the roller feeding, and
a control unit configured to perform control based on a result of a determination by the determination unit so that the air feeding unit or the roller feeding unit is selected to execute the print job.

2. The image forming apparatus according to claim 1,
wherein the determination unit,
determines additionally according to at least one of a size and a type of sheets to be printed by executing the print job whether to execute the print job by carrying out the air feeding or whether to execute the print job by carrying out the roller feeding.

3. The image forming apparatus according to claim 1,
wherein the determination unit,
in the case where a print job for which carrying out roller feeding is normally determined is present in an order sandwiched between two print jobs for which carrying out air feeding has been determined, determines that air feeding is to be executed for the print job for which carrying out roller feeding is normally determined.

4. The image forming apparatus according to claim 1,
wherein the control unit,
in the case where a print job for which carrying out roller feeding is normally determined is present in an order sandwiched between two print jobs for which carrying out air feeding has been determined, performs control so that air feeding operations of the air feeding unit are not stopped during execution of the print job for which carrying out roller feeding is normally determined.

5. The image forming apparatus according to claim 1,
wherein the control unit,
in the case where a print job for which carrying out roller feeding is normally determined is present in an order sandwiched between two print jobs for which carrying out air feeding has been determined, performs control so that the two print jobs for which carrying out air feeding has been determined are executed continuously.

6. A control method for an image forming apparatus, the image forming apparatus having an air feeding unit that carries out air feeding using air and a roller feeding unit that carries out roller feeding without using air, the control method comprising:
determining according to a number of sheets to be printed by executing a print job whether to execute the print job by carrying out the air feeding or whether to execute the print job by carrying out the roller feeding, and
performing control based on a result of a determination by the determination unit so that the air feeding unit or the roller feeding unit is selected to execute the print job.

7. The control method for an image forming apparatus according to claim 6,
wherein the determining involves,
determining additionally according to at least one of a size and a type of the sheets to be printed by executing the print job whether to execute the print job by carrying out the air feeding or whether to execute the print job by carrying out the roller feeding.

8. The control method for an image forming apparatus according to claim 6,
wherein the determining involves,
in the case where a print job for which carrying out roller feeding is normally determined is present in an order sandwiched between two print jobs for which carrying out air feeding has been determined, determining that air feeding is to be executed for the print job for which carrying out roller feeding is normally determined.

9. The control method for an image forming apparatus according to claim 6,
wherein the performing of control involves,
in the case where a print job for which carrying out roller feeding is normally determined is present in an order sandwiched between two print jobs for which carrying out air feeding has been determined, performing control so that air feeding operations of the air feeding unit are not stopped during execution of the print job for which carrying out roller feeding is normally determined.

10. The control method for an image forming apparatus according to claim 6,
wherein the performing of control involves,
in the case where a print job for which carrying out roller feeding is normally determined is present in an order sandwiched between two print jobs for which carrying out air feeding has been determined, performing control so that the two print jobs for which carrying out air feeding has been determined are executed continuously.

11. A computer-readable storage medium storing a computer program for an image forming apparatus, the image forming apparatus having an air feeding unit that carries out air feeding using air and a roller feeding unit that carries out roller feeding without using air, the program causing a computer to execute:
determining according to a number of sheets to be printed by executing a print job whether to execute the print job by carrying out the air feeding or whether to execute the print job by carrying out the roller feeding, and
performing control based on a result of a determination by the determination unit so that the air feeding unit or the roller feeding unit is selected to execute the print job.
